(19) United States
(12) Patent Application Publication
(10) Pub. No.: US 2015/0085599 A1
(43) Pub. Date: Mar. 26, 2015

(54) CONTINUOUS MAGNETIC MIXING SYSTEM WITH FLEXIBLE GEOMETRIC MIXING ZONE

(71) Applicant: XEROX CORPORATION, Norwalk, CT (US)

(72) Inventors: Yu Liu, Burlington (CA); Ke Zhou, Oakville (CA); Frank Ping-Hay Lee, Oakville (CA); Yulin Wang, Oakville (CA); Gaetano Lavigne, Burlington (CA); Jun Zhao, Mississauga (CA); Simon Burke, Burlington (CA)

(73) Assignee: XEROX CORPORATION, Norwalk, CT (US)

(21) Appl. No.: 14/037,742

(22) Filed: Sep. 26, 2013

(51) Int. Cl. B01F 13/08

(52) U.S. Cl. CPC B01F 13/0809
USPC 366/144; 366/273

(57) ABSTRACT

A mixing process and system can include a plurality of magnetic particles within a fluid such as a liquid or solid to be mixed. The fluid to be mixed is dispensed within a mixing zone that may include a mixing tube. Two or more opposing electromagnets are independently activated out of sync to affect a travel path of the magnetic particles to form a turbulence within the fluid to provide an effective mixing of the fluid. The magnetic particles may be removed from the fluid, for example by filtering, or may remain within the fluid.

### TECHNICAL FIELD

The present teachings relate to the field of fluid manufacture and, more particularly, to a method and system for mixing a fluid, for example in a continuous mixing system.

### BACKGROUND

In industry, batch processes may be used to form a desired quantity of a material such as a fluid. However, it is typically difficult to control and minimize batch-to-batch variations. Once quality standards for a particular batch are not met, the entire batch is often rejected and scrapped prior to completion of the batch to prevent further waste of raw materials.

In many batch processes, mixing of a fluid may be a critical process that determines an overall performance of the completed material. For example, in applications where small-sized particles are produced, achieving the small scale and uniform distribution of the particles is determined by the mixing process. Present mixing methods and systems may provide less than uniform mixing efficiency across an entire mixing zone. Mixing may be localized at a central mixing point, for example where an impeller tip for agitation of the fluid is located. Mixing efficiency may decay with increasing distances of the fluid from the impeller tip. Dead spots or shallow spots with inefficient mixing resulting from, for example, fluid turbulence may be distributed along edges of a shaft to which the impeller is mounted. Additionally, a curved vessel or container may result in insufficient mixing.

Other mixing systems and methods may generate more complex setups and have other undesirable characteristics, such as an increased number of mechanical parts that must be serviced and repaired. In another type of system, acoustic techniques have been employed in an attempt to avoid inefficient mixing. An acoustic mixing system may include a non-contact technique to provide micro scale mixing within a micro zone of about 50 μm in a closed vessel. However, generating an acoustic wave relies on mechanical resonance as controlled by engineered plates, eccentric weights, and springs. Particular care and protection of the mechanism to generate mechanical resonance is typically used as small turbulence may damage the system. Therefore, the overall service life of an acoustic system is limited to the effective lifetime of the mechanical components. Thus, such systems are not free of mechanical maintenance. Further, acoustic energy decays at increasing distances of the fluid away from the acoustic wave source.

Though batch processing is a common manufacturing technique that is sufficient for many technologies, it can be wasteful and may complicate future project planning. Continuous processing of a material may be practiced, depending on the industry. See, for example, published US Pub. 2011/0015320 and U.S. Pat. No. 8,168,699, each of which is incorporated herein by reference in its entirety. In continuous processing (i.e., continuous flow process or continuous production), processing of dry or fluid material occurs continuously rather than in batch processing. Constant efforts to prompt new and facile process with compact system design and effective energy saving would be beneficial for process maintenance, lowering production costs, and enhanced process robustness.

Thus, there is a need for a new and improved mixing method and system that overcomes various problems that may be encountered with some conventional systems.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

In an embodiment of the present teachings, a system for mixing a fluid may include a first electromagnet phase and a second electromagnet phase, a receptacle for receiving a fluid to be mixed, wherein the receptacle is interposed between the first electromagnet phase and the second electromagnet phase, and a controller configured to activate the first electromagnet phase out of sync with the second electromagnet phase.

In another embodiment of the present teachings, a method for continuous mixing of a fluid may include pumping a fluid to be mixed into a mixing receptacle, introducing a plurality of magnetic particles into the fluid to be mixed, activating a first electromagnet phase, and activating a second electromagnet phase out of sync with the activation of the first electromagnet phase as the fluid to be mixed and the magnetic particles are within the mixing receptacle, thereby altering a travel path of the plurality of magnetic particles within the fluid to be mixed, wherein the mixing receptacle is interposed between the first electromagnet phase and the second electromagnet phase.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a cross section depicting a mixing zone in accordance with an embodiment of the present teachings; and

FIG. 2 is a schematic perspective depiction (ghost view) of a mixing zone in accordance with an embodiment of the present teachings.

It should be noted that some details of the FIGS. have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same or like parts.

The disclosed embodiments relate generally to a method and system for magnetic actuated mixing which use magnetic particles and electromagnetic field to facilitate the mixing. The disclosed embodiments may be used in many different applications, including for example, preparing toners, inks, wax, pigment dispersions, paints, photoreceptor materials, pharmaceuticals, and the like.

In an embodiment of the present teachings, a continuous magnetic mixing apparatus and process can be used during the manufacture of a fluid such as a solid powder or liquid material. Various geometric designs of the mixing zone are contemplated. As an embodiment may use micro size magnetic particles for mixing, the embodiment does not require an external mixer and thus the mixing zone may be designed with a desired shape to enhance production or mixing. A varying magnetic field may be provided by one or more electromagnets. The mixing zone may include a horizontal flowing direction, a vertical flowing direction, or a flowing direction that is between horizontal and vertical. An embodiment may allow for the increase of reactant loading in a compact layout, thus enhancing heat transfer effectiveness, reducing manufacturing cost, alleviating difficulty on machining process, and providing a system that is accessible and easily maintained.

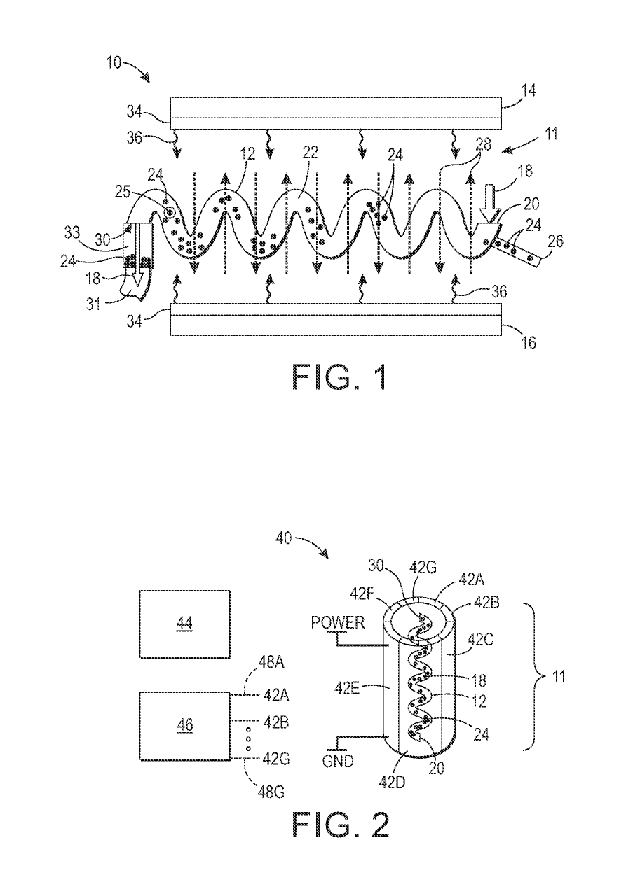

An exemplary mixing zone 11 of a mixing system, apparatus, or structure 10 and process in accordance with an embodiment of the present teachings is depicted in the cross section of FIG. 1. The FIG. 1 system may include a receptacle 12, for example a mixing tube 12 as depicted in FIG. 1, such as a glass, plastic, polymer, quartz, or metal receptacle interposed between at least a first electromagnet phase 14 and an opposing second electromagnet phase 16. In an embodiment, the first electromagnet phase 14 and the second electromagnet phase 16 may be two phases of a single electromagnet. In another embodiment, the first electromagnet phase 14 may be a first phase of a first electromagnet and second electromagnet phase 16 may be a first phase of a second electromagnet. An apparatus in accordance with the present teachings may include more than two electromagnets or electromagnet phases, such as an electromagnet coil that surrounds the mixing tube 12 with a plurality of electromagnets, or a single electromagnet having more than two phases.

During a continuous mixing process, a fluid 18 to be mixed is injected or otherwise dispensed through a tube inlet 20 into a hollow center 22 of the mixing tube 12. In an embodiment, a plurality of magnetic particles 24 may be mixed into the fluid 18 prior to injection into the mixing tube 12. In another embodiment, the mixing tube 12 may include a magnetic particle inlet 26 through which magnetic particles 24 are injected into the fluid 18 as the fluid 18 is injected into the mixing tube 12.

In an embodiment, the magnetic particles may be micro sized or nano sized. For example, the magnetic particles may be between about 10 nanometers (nm) and about 10 millimeters (mm), or between about 200 nm and about 5 mm, or between about 1000 nm and about 1 mm. Further, the magnetic particles 24 may include, for example, iron (e.g., carbonyl iron), cobalt, nickel, and mixtures or alloys of these metals. Additionally, to reduce chemical reactivity of the magnetic particles with the fluid 18, each magnetic particle may be encapsulated within a chemically inert material such as a polymer. A diameter of the hollow center 22 of the mixing tube 12 may be determined by the desired flow rate of the fluid 18, a viscosity of the fluid 18, and the diameter of the plurality of magnetic particles 24. In general, the diameter of the hollow center 22 may be, for example, between about 10 times and about 100 million times the average diameter of the plurality of magnetic particles 24, or between about 100 times and about 1 million times the average diameter of the plurality of magnetic particles 24.

As the fluid 18 and magnetic particles 24 flow through the mixing tube 12, each electromagnet phase 14, 16 is pulsed out of phase (i.e., out of sync) with the other electromagnet phase(s) to form a varying magnetic field 28 that drives the magnetic particles 24 to move through the fluid 18. Movement of the magnetic particles 24 through the fluid 18 generates turbulence within the fluid 18, thereby mixing the components of the fluid 18. The frequency and amplitude of the electromagnet phase pulses may be determined in part by the viscosity of the fluid 18 and the size and shape of the magnetic particles 24. In a two-electromagnet phase embodiment, the two electromagnet phases 14, 16 may be activated out of sync, for example 180° out of sync, so that the magnetic particles 24 pulse back and forth within the mixing tube 12. In an embodiment, an axis of each electromagnet phase 14, 16 is parallel with an axis of the mixing tube 12, such that the mixing tube 12 is interposed between the two electromagnet phases 14, 16.

To further enhance mixing or to extend the time the fluid remains in the mixing zone 11 (i.e., the fluid residence time), the mixing tube 12 may include various shapes such as the coil shape depicted in FIG. 1. A coil shape effectively increases the length of travel of the fluid within the mixing zone 11 compared to, for example, a straight mixing tube, and therefore increases mixing time for a given fluid velocity through the mixing tube 12. A coil shape further increases turbulence within the fluid and may therefore improve mixing. In this embodiment, the length of the coiled mixing tube within the mixing zone 11 may be substantially longer than the width of the mixing zone 11 itself, thus providing a compact mixing apparatus design. The mixing tube 12 may be positioned along a generally horizontal axis, a generally vertical axis, or at an oblique axis.

Once the fluid travels through the mixing zone 11 of FIG. 1, the fluid 18 may be ejected or expelled from the mixing tube 12 through a mixing tube outlet 30, for example into another mixing tube 31 to route the fluid to another location. In an embodiment, the magnetic particles 24 are inert, for example if coated with a material such as a stable polymer, which stays suspended within the fluid during use of the fluid. One magnetic particle 24 having a coating 25 is depicted in FIG. 1. The magnetic particles 24 used for mixing of the fluid may provide some utility during use of the fluid, for example as a dry lubricant that forms a plurality of micro- or nano-sized bearings. In another embodiment, the magnetic particles 24 may be removed from the fluid for recycling or for reuse during subsequent fluid mixing. In an embodiment, magnetic particles 24 may be removed or filtered from the fluid 18 by passing the fluid 18 and magnetic particles 24 through a collector 33 that is in fluid communication with the mixing tube outlet 30. In an embodiment, collector 33 may be a mesh filter, wherein openings through the mesh are smaller than the magnetic particles 24. In another embodiment, collector 33 may be a magnet over which the magnetic particles 24 are passed to remove the magnetic particles 24 from the non-magnetic fluid 18. In another embodiment, collector 33 may be a centrifugal filter that removes 24 from the fluid 18 using a centrifugal process, as long as the process does not result in undue separation of the mixed components of the fluid 18.

The FIG. 1 system thus improves mixing of the fluid 18 by electrically activating the electromagnet phases (which may be two or more phases of two or more electromagnets, or two or more phases of a single electromagnet) to magnetically control the movement of the magnetic particles 24 through the fluid 18. An embodiment may further include other elements that improve mixing of the fluid 18. For example, FIG. 1 further depicts one or more heating and/or cooling structures 34 that provide a heating and/or cooling zone. The heating and/or cooling structures 34 may be an electric heater/cooler, a blower, etc. having an output 36 that changes the temperature of the fluid 18 within the mixing tube 12. In an embodiment, the heating and/or cooling zone may be an area interposed between the one or more heating and/or cooling structures 34. In another embodiment, the heating/cooling zone may be an area where the temperature of the fluid 18 is influenced or changed by structures 34. The heating and/or cooling zone may be congruent or non-congruent with the mixing zone 11, for example depending on the length of the heating and/or cooling structures 34 or the area where temperature is influenced by structures 34. It will be appreciated that structure 34 may be a single heating and/or cooling structure 34 that surrounds the cooling zone, or a plurality of individual structures that cooperate to heat and/or cool the fluid 18 as it passes through the mixing zone 11. Heating the fluid 18 with structures 34 may be useful in decreasing the viscosity of the fluid 18 within the mixing tube 12 and increasing the speed of a chemical reaction between the components within the mixing tube 12 in certain uses. Cooling the fluid 18 with structures 34 may be useful in increasing the viscosity of the fluid 18 within the mixing tube 12 and decreasing the speed of a chemical reaction between components within the mixing tube 12 in certain uses.

FIG. 2 is a schematic perspective depiction of a system 40 in accordance with an embodiment of the present teachings having a plurality of electromagnet phases, for example eight electromagnet phases 42A-42G that completely surround the mixing tube 12 through 360°. The electromagnet phases 42A-42G may be a eight of phases of a single electromagnet, or eight phases of eight different electromagnets. Each electromagnet phase 42A-42G may be independently powered through a power and ground connection (only one of which is schematically depicted in FIG. 2) to each electromagnet phase. A power supply 44 may be used to power the electromagnets 42A-42G, and may also power a controller 46. The controller 46, through an independent signal 48A-48G to each electromagnet phase 42A-42G, activates each electromagnet phase in succession to control the movement of the magnetic particles 24 within the fluid 18 in the mixing tube 12. The controller 46 may include electronics such as control relays for switching the direction of the magnetic field between the two or more electromagnet phases.

Thus, an arrangement of the mixing tube 12 and actuation of the electromagnet phases 42A-42G by the controller 46 may be designed to provide efficient mixing of the fluid 18 within the mixing tube 12 within a mixing zone 11 that is compact. For example, in an embodiment, the mixing tube 12 may coil in a first direction (for example clockwise or counterclockwise) from the bottom to the top. The fluid 18 may be dispensed into the mixing tube 12 through the inlet 20 at the bottom of the mixing tube 12 and mixed within the mixing tube 12 using the magnetic particles 24. After mixing, the fluid 18 exits through the mixing tube outlet 30.

In an embodiment, the controller 46 may activate each electromagnet phase 42A-42G successively in a second direction that is opposite to the first direction (for example counterclockwise or clockwise) such that the magnetic particles 24 resist the flow of the fluid 18 from the inlet 20 to the mixing tube outlet 30, thus providing a higher turbulence within the fluid for effective mixing of fluid 18 components within the mixing tube 12. Further, the controller 46 may vary the direction of the electromagnet phase activation from counterclockwise to clockwise during the mixing process to further increase turbulence. Various other magnetic particle 24 travel patterns and mixing tube arrangements are contemplated.

Thus, an embodiment of the present teachings may include a continuous magnetic mixing process and structure that has minimal geometric limitations on the size and shape of the mixing zone 11. The apparatus and process does not require an external mixer such as an impeller. The mixing zone 11 as depicted in FIG. 1 may be designed with arbitrary three dimensional (3D) shape such as the coil depicted. A varying magnetic field is provided by two or more electromagnetic phases with flexible design consideration, for example, with respect to a horizontal, vertical, or oblique flowing direction. The design may increase reactant loading in a compact layout, enhance heat transfer effectiveness, reduce manufacturing costs, alleviate difficulty on machining process, and allow for simpler maintenance compared to some mixing systems. A continuous mixing system in accordance with an embodiment of the present teachings may have a decreased size, reduced equipment complexity and machining strictness, and enhanced energy utilization, for example heat transfer efficiency. Magnetic particles are introduced into a fluid including one or more components to be mixed. A magnetic field is supplied and varied along the flowing direction to introduce designed travel patterning of the magnetic particles in the flow. This process may introduce continuous mixing in any geometric design of the mixing zone, such as a coil-shaped mixing zone.

The continuous mixing process and structure may be used during the manufacture of various materials such as during the preparation of printer and other toners, inks, wax, pigment dispersions, paints such as latex paints, photoreceptor materials, pharmaceuticals, and the like.

It will be understood that the embodiments depicted in the FIGS. are generalized schematic illustrations and that other components may be added or existing components may be removed or modified.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

Terms of relative position as used in this application are defined based on a plane parallel to the conventional plane or working surface of a workpiece, regardless of the orientation of the workpiece. The term “horizontal” or “lateral” as used in this application is defined as a plane parallel to the conventional plane or working surface of a workpiece, regardless of the orientation of the workpiece. The term “vertical” refers to a direction perpendicular to the horizontal. Terms such as “on,” “side” (as in “sidewall”), “higher,” “lower,” “over,” “top,” and “under” are defined with respect to the conventional plane or working surface being on the top surface of the workpiece, regardless of the orientation of the workpiece.

1. A system for mixing a fluid, comprising:
a first electromagnet having a first phase and a second electromagnet having a second phase;
a receptacle for receiving a fluid to be mixed, wherein the receptacle is interposed between the first electromagnet and the second electromagnet; and
a controller configured to activate the first phase out of sync with the second phase.

2. The system of claim 1, further comprising a plurality of magnetic particles wherein the first electromagnet and the second electromagnet are configured to change a travel path of the plurality of magnetic particles during a mixing process.

3. The system of claim 2, further comprising a chemically inert coating covering each of the plurality of magnetic particles.

4. The system of claim 2, further comprising a fluid to be mixed, wherein the plurality of magnetic particles are within the fluid and the fluid is within the receptacle.

5. The system of claim 4, further comprising:
a receptacle inlet; and
a receptacle outlet, wherein the fluid mixing system is configured to mix the fluid as the fluid flows through the receptacle from the receptacle inlet to the receptacle outlet.

6. The system of claim 5, further comprising a collector in fluid communication with the outlet to collect used magnetic particles.

7. The system of claim 2, wherein each magnetic particle of the plurality of magnetic particles has a size in the range of from 10 nanometers to 10 millimeters.

8. The system of claim 1, wherein the receptacle is a coiled mixing tube.

9. The system of claim 8, further comprising:
a plurality of electromagnets that surround the coiled mixing tube in its entirety, wherein each of the plurality of electromagnets comprises a phase;
the coiled mixing tube comprises a mixing tube inlet and a mixing tube outlet;
the coiled mixing tube is wound in a first direction from the mixing tube inlet to the mixing tube outlet; and
the controller is configured to electrically activate the plurality of phases of the plurality of electromagnets successively in the first direction.

10. The system of claim 9, wherein the controller is further configured to electrically activate the plurality of phases of the plurality of electromagnets successively in a second direction that is opposite to the first direction.

11. The system of claim 1, further comprising at least one of a heating zone and a cooling zone surrounding the receptacle.

12. A system for mixing a fluid, comprising:
an electromagnet comprising a first phase and a second phase;
a receptacle for receiving a fluid to be mixed, wherein the receptacle is interposed between the first phase and the second phase; and
a controller configured to activate the first phase out of sync with the second phase.

13. The system of claim 12, further comprising a plurality of magnetic particles wherein the first phase and the second phase are configured to change a travel path of the plurality of magnetic particles during a mixing process.

14. The system of claim 13, further comprising a fluid to be mixed, wherein the plurality of magnetic particles are within the fluid and the fluid is within the receptacle.

15. A method for continuous mixing of a fluid, comprising:
pumping a fluid to be mixed into a mixing receptacle;
introducing a plurality of magnetic particles into the fluid to be mixed;
activating a first electromagnet phase; and
activating a second electromagnet phase out of sync with the activation of the first electromagnet phase as the fluid to be mixed and the magnetic particles are within the mixing receptacle, thereby altering a travel path of the plurality of magnetic particles within the fluid to be mixed, wherein the mixing receptacle is interposed between the first electromagnet phase and the second electromagnet phase.

16. The method of claim 15, wherein the mixing receptacle is a coiled mixing tube comprising a mixing tube inlet and a mixing tube outlet, and the method further comprises:
pumping the fluid to be mixed into the mixing tube inlet;
flowing the fluid to be mixed and the plurality of magnetic particles through the coiled mixing tube and out of the coiled mixing tube through the mixing tube outlet during the activation of the first electromagnet phase and the activation of the second electromagnet phase out of sync with the first electromagnet phase.

17. The method of claim 16, wherein the introduction of the plurality of magnetic particles into the fluid to be mixed introduces a plurality of magnetic particles comprising at least one of iron, cobalt, nickel, and mixtures and alloys thereof.

18. The method of claim 16, wherein the coiled mixing tube is coiled in a first direction from the mixing tube inlet to the mixing tube outlet and the method further comprises activating a plurality of electromagnet phases successively in a second direction that is opposite to the first direction.

19. The method of claim 18, further comprising activating the plurality of electromagnet phases successively in the first direction.

20. The method of claim 18, further comprising pre-loading the plurality of magnetic particles within the mixing receptacle prior to pumping the fluid to be mixed into the mixing receptacle.
